(19) United States
(12) Patent Application Publication
(10) Pub. No.: US 2021/0282414 A1
(43) Pub. Date: Sep. 16, 2021

(54) Bread Cup and Method of Manufacture

(71) Applicant: Michael Lyon, Las Vegas, NV (US)

(72) Inventor: Michael Lyon, Las Vegas, NV (US)

(21) Appl. No.: 16/815,418

(22) Filed: Mar. 11, 2020

(51) Int. Cl. A21D 13/33; A47J 37/01; B65D 65/46; B65D 51/28; A47J 43/20; A21B 3/13

(52) U.S. Cl. CPC A21D 13/33; A47J 37/01; A21B 3/133; B65D 51/28; A47J 43/20; B65D 65/463

(57) ABSTRACT

A bread cup for holding a food material and a condiment container has a cup body made of bread. The cup body has a base and an upwardly extending side wall that extends upwardly to a top perimeter, forming an interior bore that is adapted to receive the food material. The bread cup further includes a lid made of bread that has a top surface and an opposed bottom surface that together extend outwardly to a lid perimeter, the lid perimeter being sized and shaped to rest upon the top perimeter of the cup body for covering the interior bore of the cup body. A condiment receiving bore is formed in the top surface of the lid, the condiment receiving bore being sized and shaped to receive the condiment container therein.

### BACKGROUND OF THE INVENTION

### Field of the Invention

This invention relates generally to bread cups, and more particularly to a bread cup with a lid and method of manufacture.

### Description of Related Art

Bread cups are commonly known in the art as being hollowed-out after baking, without a separately formed lid. For example, a bread “bowl” may use its own crust as a lid, which is difficult to easily open and close. Goldstein, U.S. Pat. No. 10,440,964, teaches an automated system and method for manufacturing a cone-shaped food product holder, using a conveyer which advances a bread dough strip at a constant linear velocity, forming the cone shape. Other examples in the prior art may have container molds which are openable to access baked bread, such as in a standard domestic bread maker.

The prior art teaches bread molds and bread cups. However, the prior art does not teach a bread cup and method of manufacture which includes a separately formed lid adapted to hold a condiment. The present invention fulfills these needs and provides further advantages as described in the following summary.

### SUMMARY OF THE INVENTION

The present invention teaches certain benefits in construction and use which give rise to the objectives described below.

The present invention provides a bread cup for holding a food material and a condiment container. The bread cup comprises a cup body made of bread, the cup body having a base and an upwardly extending side wall that extends upwardly to a top perimeter, the cup body forming an interior bore that is adapted to receive the food material. The bread cup further includes a lid made of bread that has a top surface and an opposed bottom surface that together extend outwardly to a lid perimeter, the lid perimeter being sized and shaped to rest upon the top perimeter of the cup body for covering the interior bore of the cup body. A condiment receiving bore is formed in the top surface of the lid, the condiment receiving bore being sized and shaped to receive the condiment container therein.

A primary objective of the present invention is to provide a bread cup having advantages not taught by the prior art.

Another objective is to provide a method of manufacturing a bread cup.

A further objective is to provide a bread cup that has a lid with a condiment receiving bore.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is an exploded perspective view of a bread cup with a lid according to one embodiment of the present invention;

FIG. 2 is a side elevational view thereof;

FIG. 3 is an exploded perspective view of a cup mold having a male insert;

FIG. 4 is a perspective view of the assembled cup mold receiving bread dough;

FIG. 5 is a cross-sectional view of the cup mold containing the bread dough and the male insert;

FIG. 6 is a perspective view of a lid mold having a plurality of recesses, further illustrating a top grid with studs attached thereto; and

FIG. 7 is a cross-sectional view of one of the recesses of the lid mold containing bread dough, showing one of the studs of the top grid being positioned in an approximate center of the bread dough.

### DETAILED DESCRIPTION OF THE INVENTION

The above-described drawing figures illustrate the invention, a bread cup 10 for holding a food material 12 and a condiment container 14, and method of manufacturing the bread cup 10.

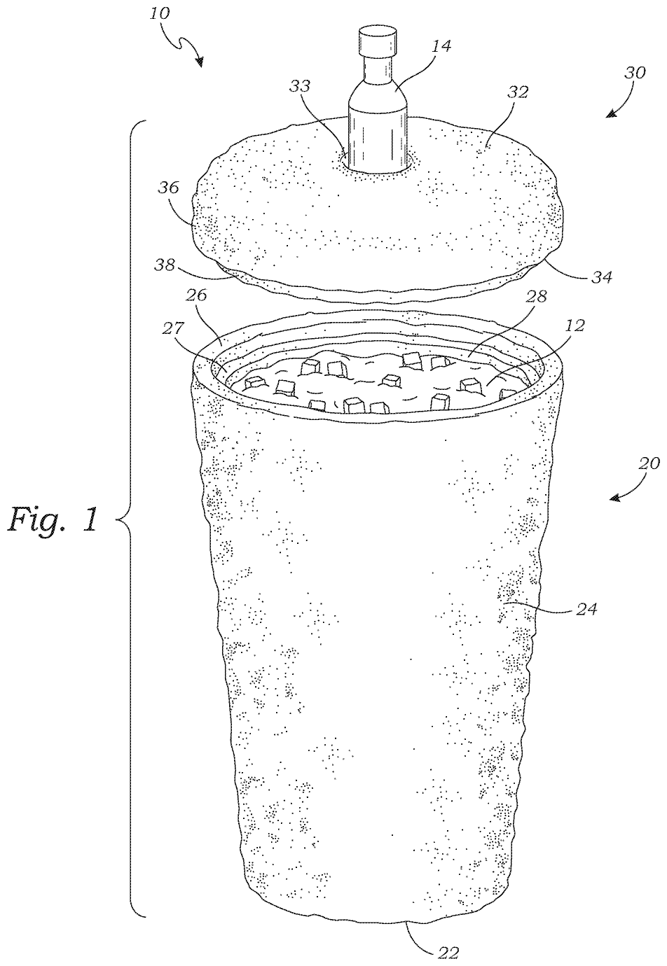

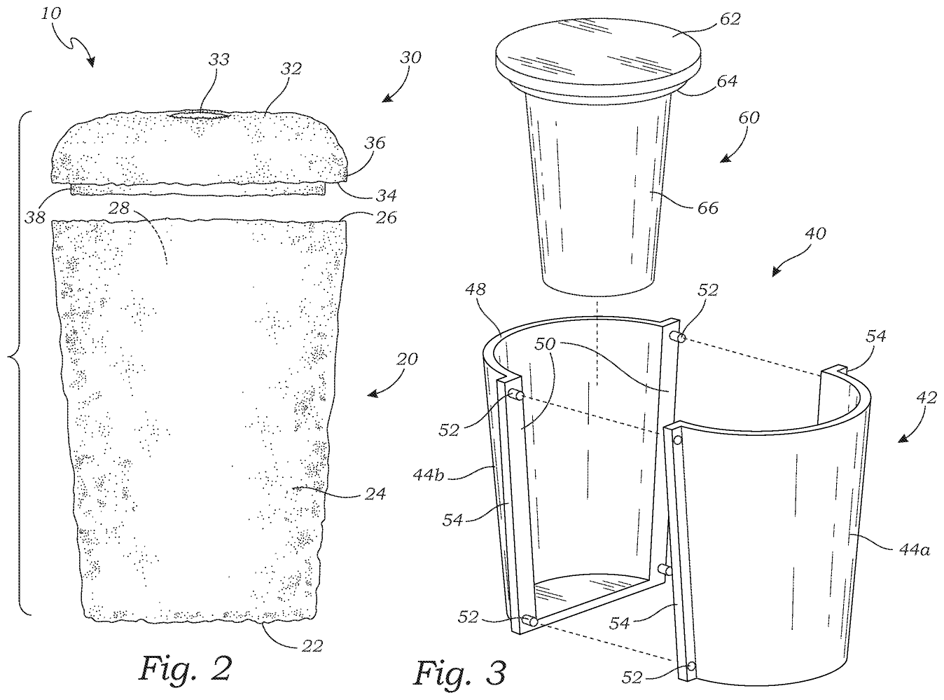

FIG. 1 is an exploded perspective view of the bread cup 10 with a lid 30 according to one embodiment of the present invention, and further showing the condiment container 14 and the food material 12. FIG. 2 is a side elevational view thereof. As shown in FIGS. 1-2, the bread cup 10 comprises a cup body 20 made of bread, the cup body 20 having a base 22 and an upwardly extending side wall 24 that extends upwardly to a top perimeter 26, forming an interior bore 28 that is adapted to receive the food material 12. In this embodiment, the cup body 20 is frustoconical in shape, but in other embodiments, the cup body 20 may be provided in alternative shapes (e.g., round/spherical, cuboid, bowl-shaped, or any other shapes desired by one skilled in the art). The food material 12 may be any type of food which may be contained within a bread container, e.g., chili, clam chowder, mac&cheese, cheese sauce, soup, meat, etc., or any other type of suitable food materials. The condiment container 14 may contain any form of condiment, e.g., ketchup, mustard, mayonnaise, hot sauce, chocolate, caramel, or any other known in the art.

The lid 30 is also made of bread and includes a top surface 32 and an opposed bottom surface 34 that together extend outwardly to a lid perimeter 36. The lid perimeter 36 may be sized and shaped to rest upon the top perimeter 26 of the cup body 20 for covering the interior bore 28 of the cup body 20. In this embodiment, the lid 30 is disk-shaped, and includes a platform 38 on the bottom surface 34 that rests on a lip 27 of the top perimeter 26 of the cup body 20. However, in other embodiments, the lid 30 may be any shape suitable for covering the top perimeter 26 of the cup body 20. The lid 30 further comprises a condiment receiving bore 33 formed in the top surface 32 of the lid 30, the condiment receiving bore 33 being sized and shaped to receive the condiment container 14 therein.

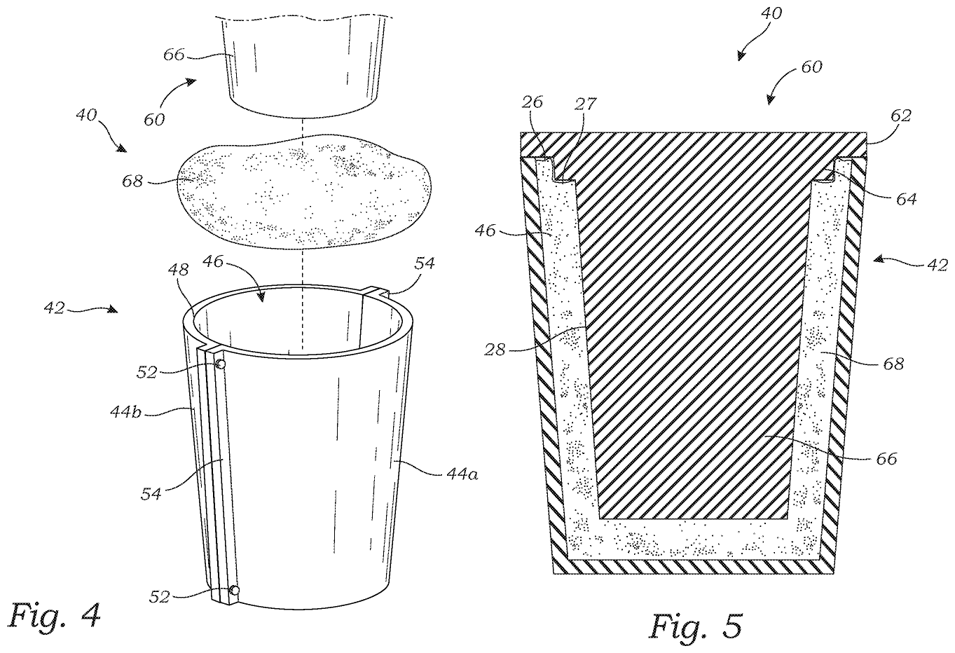

FIG. 3 is an exploded perspective view of a cup mold 40 having a male insert 60. The cup mold 40 may be provided and used in the method of producing the bread cup 10. As shown in FIG. 3, the cup mold 40 comprises a cup-shaped main shell 42 and the male insert 60. However, as discussed above, the cup mold 40 may be provided in alternative shapes to form the bread cup 10. The cup-shaped main shell 42 is formed of separable first and second halves 44a and 44b which, when combined together, form a receiving space 46 having an upper opening 48 (best shown in FIGS. 4-5). In some embodiments, the first and second halves 44a and 44b of the main shell 42 include respective mating surfaces 50, the mating surfaces 50 having fasteners 52 for fastening the first and second halves together. In the embodiment of FIG. 3, the mating surfaces 50 include flanges 54 having the fasteners 52, the fasteners 52 being pins with receivers. However, in other embodiments, the fasteners 52 may be in the form of a latch, lock, stud, etc. The first and second halves may further be attached via another means, e.g., snapped together, slidably attached, etc.

The male insert 60 is shaped to fit into the cup-shaped main shell 42, and may include an upper plate 62 with a central raised platform 64, and an elongate post 66 that extends downwardly from the central raised platform 64, discussed in greater detail below.

FIG. 4 is a perspective view of the assembled cup mold 40 receiving bread dough 68, and FIG. 5 is a cross-sectional view of the cup mold 40 containing the bread dough 68 and the male insert 60. The method of producing the bread cup 10 involves first connecting the first and second halves 44a and 44b of the cup-shaped main shell 42, and then inserting bread dough 68 into the receiving space 46 of the main shell 42. The male insert 60 is inserted into the cup-shaped main shell 42, pushing the bread dough 68 into the cup shape. In this embodiment, the upper plate 62 of the male insert 60 rests on the upper opening 48 of the cup-shaped main shell 42, such that the central raised platform 64 and the elongate post 66 extend into the receiving space 46, wherein the elongate post 66 forms the interior bore 28 of the bread cup 10, and the central raised platform 64 forms the lip 27 of the bread cup 10.

The bread dough 68 is then baked within the cup mold 40, and once baked, the male insert 60 is removed from within the cup-shaped main shell 42. The first and second halves 44a and 44b of the cup-shaped main shell 42 are then separated to allow removal of the bread cup 10. Additional steps may be included in the method of producing the bread cup 10, e.g., a proofing process for proofing the bread dough 68, a flavoring process, a cooling step to facilitate removal of the bread cup 10 from the separated first and second halves 44a and 44b, etc. Other steps may also be added to the method, which should be considered within the scope of the present invention.

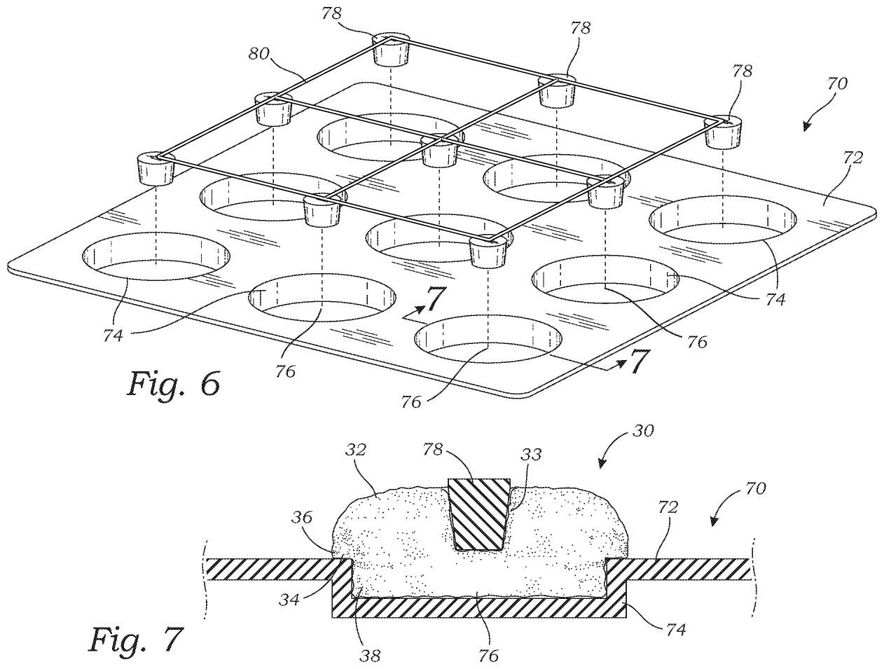

FIG. 6 is a perspective view of a lid mold 70, and further illustrates a top grid 80 with studs 78 attached thereto. The lid mold 70 comprises a sheet 72 having at least one recess 74, in this embodiment a plurality of recesses 74 being generally circular and sized to fit into the lip 27 of the bread cup 10. The method of producing the lid 30 of the bread cup 10 may use the top grid 80 having the plurality of studs 78 attached thereto, each of the plurality of studs 78 being held by the top grid 80 in a pattern that matches the plurality of recesses 74 of the lid mold 70. When the top grid 80 is placed over the lid mold 70, each of the studs 78 may be positioned approximately in a center 76 of each of the plurality of recesses 74.

FIG. 7 is a cross-sectional view of one of the recesses 74 of the lid mold 70 containing bread dough 82, showing one of the studs 78 of the top grid 80 being positioned in the approximate center 76 of the bread dough 82. First, the bread dough 82 is inserted into the recess 74, then one of the studs 78 is inserted into the bread dough 82 in the recess 74, to form the bore 33 in the bread dough 82. The bread dough 82 is then baked within the lid mold 70 to form the lid made of bread 30, wherein the stud 78 is removed from the lid 30, and the lid 30 is removed from the recess 74 of the lid mold 70. Additional steps may be included in the method of producing the lid 30, e.g., a proofing process for proofing the bread dough 82, a flavoring process, a cooling step to facilitate removal of the lid 30 from the lid mold 70, etc. Other steps may also be added to the method, as deemed necessary by one skilled in the art.

For the purposes of this application, “bread” and similar terms such as “bread dough” are hereby defined to include any base material suitable for baking in a mold, including cookie dough, pie crust, cornbread, pasta dough, etc., or any other similar materials known in the art. While one example of a material is discussed above, it should be understood that alternative baking materials may be used in the method of manufacture, which is considered within the scope of the present invention.

As used in this application, the words “a,” “an,” and “one” are defined to include one or more of the referenced item unless specifically stated otherwise. The terms “approximately” and “about” are defined to mean+/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A bread cup for holding a food material and a condiment container, the bread cup comprising:
a cup body made of bread, the cup body having a base and an upwardly extending side wall that extends upwardly to a top perimeter, the cup body forming an interior bore that is adapted to receive the food material;
a lid made of bread that includes a top surface and an opposed bottom surface that together extend outwardly to a lid perimeter, the lid perimeter being sized and shaped to rest upon the top perimeter of the cup body for covering the interior bore of the cup body; and
a condiment receiving bore formed in the top surface of the lid, the condiment receiving bore being sized and shaped to receive the condiment container therein.

2. The bread cup of claim 1, wherein the lid is disk-shaped, and wherein the cup body is frustoconical in shape

3. A method of producing a bread cup with a lid, the method comprising the steps of:
providing a cup mold having a cup-shaped main shell and a male insert, wherein the cup-shaped main shell is formed of separable first and second halves which, when combined together, form a receiving space having an upper opening, and wherein the male insert is shaped to fit into the cup-shaped main shell;
connecting the first and second halves of the cup-shaped main shell;
inserting bread dough into the receiving space of the main shell;
inserting the male insert into the cup-shaped main shell;
baking the bread dough within the cup mold;
removing the male insert from within the cup-shaped main shell; and
separating the first and second halves of the cup-shaped main shell to allow removal of the bread cup.

4. The method of claim 3, further comprising the steps of:
providing a lid mold having a recess;
inserting bread dough into the recess;
inserting a stud into the bread dough in the recess, to form a bore in the bread dough;
baking the bread dough within the lid mold to form a lid made of bread;
removing the stud from the lid made of bread; and
removing the lid made of bread from the recess of the lid mold.

5. The method of claim 4, wherein the lid mold comprises a sheet having a plurality of the recesses.

6. The method of claim 5, further comprising the steps of:
providing a top grid that includes a plurality of studs attached thereto, each of the plurality of studs being held by the top grid in a pattern that matches the plurality of recesses of the lid mold; and
placing the top grid over the lid mold so that each of the studs is positioned approximately in a center of each of the plurality of recesses.
